(19) United States
(12) Patent Application Publication
(10) Pub. No.: US 2015/0350077 A1
(43) Pub. Date: Dec. 3, 2015

(54) Techniques For Transforming Legacy Networks Into SDN-Enabled Networks

(71) Applicant: Brocade Communications Systems, Inc., San Jose, CA (US)

(72) Inventors: Muhammad Durrani, Sunnyvale, CA (US); Syed Natif Nawaz, Santa Clara, CA (US); Eswara Chinthalapati, San Jose, CA (US); Yi Zhang, Saratoga, CA (US); Sindhu Payankulath, Fremont, CA (US)

(21) Appl. No.: 14/721,978

(22) Filed: May 26, 2015

Related U.S. Application Data
(60) Provisional application No. 62/005,177, filed on May 30, 2014.
(60) Provisional application No. 62/089,028, filed on Dec. 8, 2014.

(51) Int. Cl. H04L 12/741; H04L 12/717; H04L 29/08; H04L 12/715

(52) U.S. Cl. CPC H04L 45/745; H04L 45/46; H04L 45/42; H04L 67/141

(57) ABSTRACT

Techniques for transforming a legacy network into a Software Defined Networking (SDN) enabled network are provided. In one embodiment, a route server can receive one or more routing protocol packets originating from a network device, where the one or more routing protocol packets are forwarded to the route server via a cross connect configured on a network router. The route server can further establish a routing protocol session between the route server and the network device based on the one or more routing protocol packets, and can add a routing entry to a local routing table. Upon adding the routing entry, the route server can automatically invoke an application programming interface (API) for transmitting the routing entry to a Software Defined Networking (SDN) controller.

### CROSS REFERENCES TO RELATED APPLICATIONS

The present application claims the benefit and priority under 35 U.S.C. 119(e) of U.S. Provisional Application No. 62/005,177, filed May 30, 2014, entitled “METHOD AND IMPLEMENTATION TO TRANSFORM LEGACY NETWORKS TO OPENFLOW ENABLED NETWORK,” and U.S. Provisional Application No. 62/089,028, filed Dec. 8, 2014, entitled “TECHNIQUES FOR TRANSFORMING LEGACY NETWORKS INTO SDN-ENABLED NETWORKS.” The entire contents of these provisional applications are incorporated herein by reference for all purposes.

### BACKGROUND

Software Defined Networking (SDN), and OpenFlow in particular (which is a standardized communications protocol for implementing SDN), have unlocked many new tools for re-imagining conventional approaches to Layer 3 networking. For instance, SDN enables a remote controller (e.g., a server computer system) to carry out control plane functions typically performed by dedicated network devices (e.g., routers or switches) in an L3 network. Examples of such control plane functions include routing protocol session establishment, building routing tables, and so on. The remote controller can then communicate, via OpenFlow (or some other similar protocol), appropriate commands to the dedicated network devices for forwarding data traffic according to the routing decisions made by the remote controller. This separation of the network control plane (residing on the remote controller) from the network forwarding plane (residing on the dedicated network devices) can reduce the complexity/cost of the dedicated network devices and can simplify network management, planning, and configuration.

Unfortunately, because SDN and OpenFlow are still relatively new technologies, customers have been slow to adopt them in their production environments. Accordingly, it would desirable to have techniques that facilitate the deployment of SDN-based networks, thereby generating confidence in, and promoting adoption of, these technologies.

### SUMMARY

Techniques for transforming a legacy network into a Software Defined Networking (SDN) enabled network are provided. In one embodiment, a route server can receive one or more routing protocol packets originating from a network device, where the one or more routing protocol packets are forwarded to the route server via a cross connect configured on a network router. The route server can further establish a routing protocol session between the route server and the network device based on the one or more routing protocol packets, and can add a routing entry to a local routing table. Upon adding the routing entry, the route server can automatically invoke an application programming interface (API) for transmitting the routing entry to a Software Defined Networking (SDN) controller.

The following detailed description and accompanying drawings provide a better understanding of the nature and advantages of particular embodiments.

### BRIEF DESCRIPTION OF DRAWINGS

FIG. 1 depicts a legacy L3 network according to an embodiment.

FIG. 2 depicts a version of the network of FIG. 1 that has been modified to support SDN conversion according to an embodiment.

FIG. 3 depicts a legacy-to-SDN conversion/transformation workflow according to an embodiment.

FIG. 4 depicts a version of the network of FIG. 2 that includes a route server cluster according to an embodiment.

FIG. 5 depicts a workflow for synchronizing routing protocol state between nodes of the route server cluster according to an embodiment.

FIG. 6 depicts a network router according to an embodiment.

FIG. 7 depicts a computer system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

Embodiments of the present disclosure provide techniques for transforming a legacy Layer 3 network (i.e., a network comprising dedicated network devices that each perform both control plane and data plane functions) into an SDN-enabled network (i.e., a network where control plane functions are separated and consolidated into a remote controller, referred to herein as a “route server,” that is distinct from the dedicated network devices). In one set of embodiments, these techniques can include configuring, by an administrator, a network router to forward routing protocol packets received from other network devices to a route server (rather than processing the routing protocol packets locally on the network router). The route server can then establish, using the received routing protocol packets, routing protocol sessions (e.g., OSPF, ISIS, BGP, etc.) directly with the other network devices. This step can include populating a routing database, calculating shortest/best paths for various destination addresses, and building a routing table with next hop information for each destination address.

Upon creating, modifying, or deleting a given routing entry in its routing table, the route server can automatically invoke a standardized application programming interface (API) for communicating information regarding the routing entry to an SDN (e.g., OpenFlow) controller. In a particular embodiment, the standardized API can be a representational state transfer (REST) API that is understood by the SDN controller. The SDN controller can store the received routing entry information in its own database (referred to herein as a flow entry database). The SDN controller can subsequently send a command to the network router that causes the routing entry to be installed/programmed into a hardware forwarding table (e.g., CAM) of the router, thereby enabling the router to forward incoming data traffic according to the routing entry at line rate.

With the approach described above, customers with legacy L3 networks can more easily migrate those legacy networks to support the SDN paradigm of having separate control and forwarding planes. This, in turn, can allow the customers to reduce their capital/operational costs (since they are no longer required to purchase and deploy dedicated network devices with complex control plane functionality), and can ensure that their networks are capable of scaling to meet ever-increasing bandwidth demands and supporting new types of network services. This is particularly beneficial for IP edge networks (i.e., networks that sit on the edge between service provider-maintained IP/MPLS networks and customer access networks), since IP edge networks are typically the service points that are under the most pressure for increasing scale and service granularity.

In certain embodiments, in addition to facilitating the transition to the SDN paradigm, the techniques described herein can also enable high availability (HA) for the route server that is configured to perform control plane functions. In these embodiments, multiple physical machines (i.e. nodes) can work in concert to act as a virtual route server cluster (using, e.g., virtual router redundancy protocol (VRRP) or an enhanced version thereof, such as VRRP-e). Network devices can communicate with a virtual IP address of the virtual route server cluster in order to establish routing protocol sessions with an active node in the cluster. Then, when a failure of the active node occurs, control plane processing can be automatically failed over from the active node to a backup node, thereby preserving the availability of the route server. In a particular embodiment, the virtual route server cluster can implement a novel technique for (1) synchronizing the routing protocol state machine for a given routing protocol session from the active node to the backup node(s) during session establishment, and (2) allowing the backup node (rather than the active node) to send out routing protocol “transmit” packets (e.g., response messages) to the originating network device. This technique can ensure that the backup node is properly synchronized with the active node and can avoid the need to rebuild the routing protocol state machine (and/or the routing database) on the backup node if a failover to that backup node occurs.

These and other aspects of the present disclosure are described in further detail in the sections that follow.

### 2. Network Environment

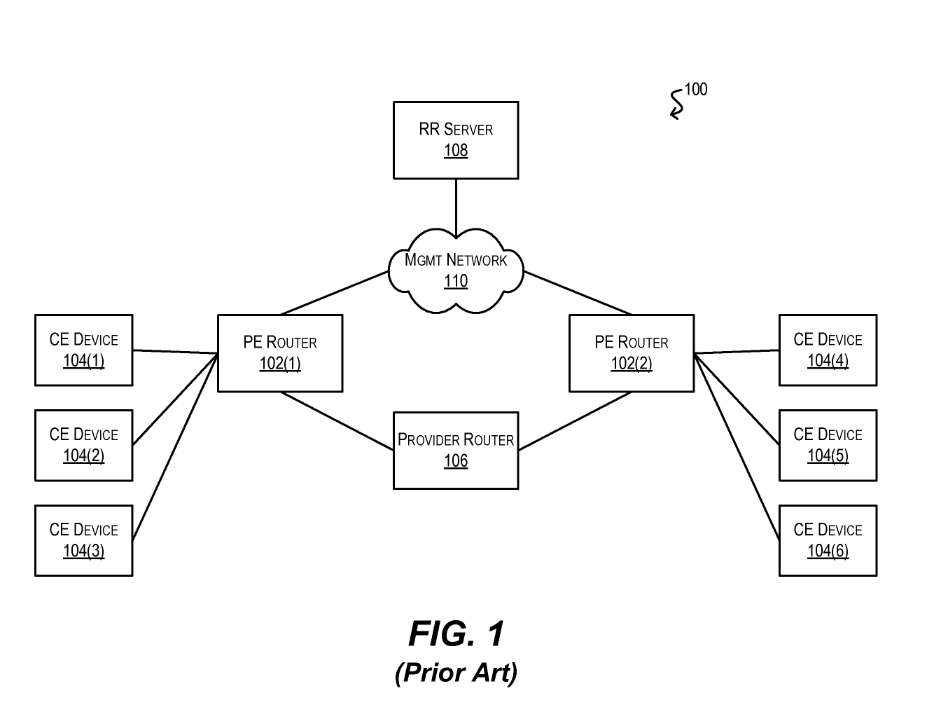

FIG. 1 depicts an example of a legacy L3 network 100 to which embodiments of the present disclosure may be applied. As shown, network 100 includes provider edge (PE) routers 102(1) and 102(2) that are connected to customer edge (CE) network devices 104(1)-(3) and 104(4)-(6) respectively. Network 100 further includes an internal provider router 106, as well as a route reflector (RR) server 108 connected to PE routers 102(1) and 102(2) via a management network 110. As known in the art, RR server 108 can act as a focal point for propagating routing protocol information within network 100 and thus avoids the need for full mesh connectivity between PE routers 102(1) and 102(2) (and any other PE routers in network 100).

In the example of FIG. 1, each CE network device 104 is configured to create routing protocol sessions with its connected PE router 102. Each PE router 102, in turn, is configured to carry out the control plane functions needed for establishing routes within the routing domain of network 100 (e.g., establishing/maintaining neighbor relationships, calculating best routes, building routing tables, etc.), as well as physical forward network traffic. As noted the Background section, one problem with performing both control plane and forwarding plane functions on dedicated network devices like PE routers 102(1)/102(2) is that this limits the scalability and flexibility of the network. This is particularly problematic in a provider edge network as shown in FIG. 1, which is often the “pressure point” for service providers when attempting to increase network scale and service granularity.

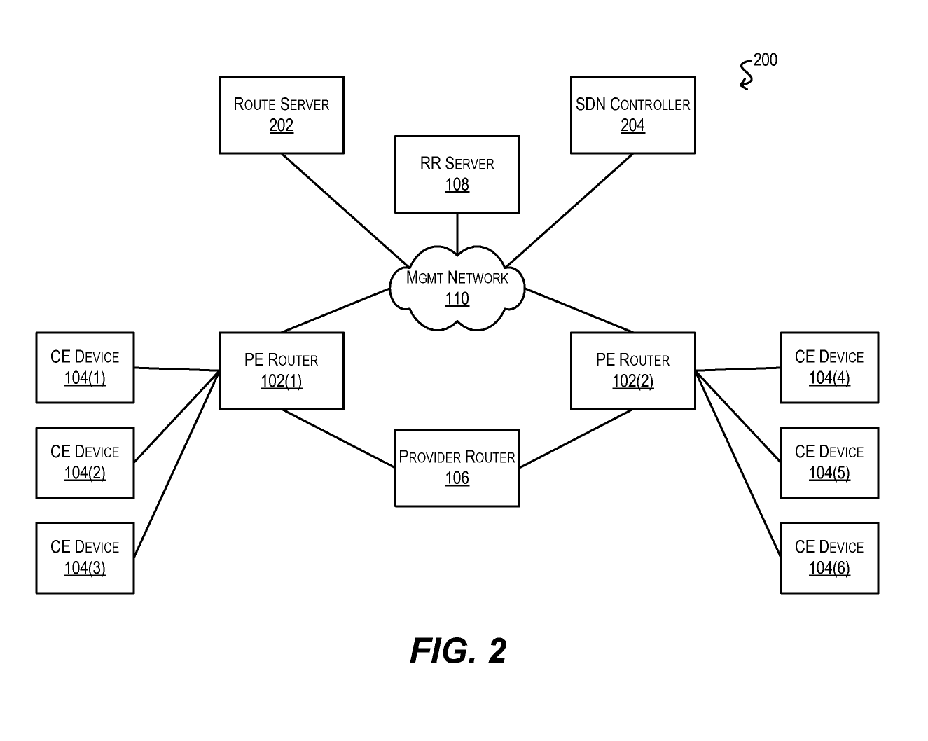

To address these and other similar issues, FIG. 2 depicts a version of network 100 (i.e., network 200) that has been modified to facilitate the transition, or transformation, of network 100 into an SDN-enabled network according to an embodiment. As shown, network 200 includes a route server 202 and an SDN controller 204 that is communicatively coupled with PE routers 102(1) and 102(2) via management network 110. Route server 202 is a software or hardware-based component that can centrally perform control plane functions on behalf of PE routers 102(1) and 102(2). In a particular embodiment, route server 202 can be an instance of Brocade Communications Systems, Inc.'s Vyatta routing server software running on a physical or virtual machine. SDN controller 204 is a software or hardware-based component that can receive commands from route server 202 (via, e.g., an appropriate “northbound” protocol) that are directed to PE routers 102(1) and 102(2), and can forward those commands (via, e.g., an appropriate “southbound” protocol, such as OpenFlow) to routers 102(1) and 102(2) for execution on those devices. In a particular embodiment, SDN controller 204 can be an instance of an OpenDaylight (ODL) controller.

As described in the next section, route server 202 and SDN controller 204 can, in conjunction with each PE router 102, carry out a workflow for automating the conversion, or transformation, of legacy network 100 of FIG. 1 into an SDN-enabled network. Stated another way, this conversion/transformation workflow can: (1) enable L3 control plane functions that were previously carried out locally on PE routers 102(1) and 102(2) (e.g., establishing routing protocol sessions, calculating best routes, building routing tables, etc.) to be automatically centralized in route server 202; and (2) enable routing entries determined by route server 202 to be automatically propagated to (i.e., programmed in) the hardware forwarding tables of PE routers 102(1) and 102(2). With this workflow, the operator of network 100 can more quickly and more easily realize the operational, cost, and scalability benefits of moving to an SDN-based network paradigm.

It should be appreciated that FIGS. 1 and 2 are illustrative and not intended to limit the embodiments discussed herein. For example, although these figures depict a certain number of each network element (e.g., two PE routers, six CE devices, etc.), any number of these elements may be supported. Further, although these figures specifically depict a provider/IP edge network, the techniques of the present disclosure may be applied to any type of legacy network known in the art. Yet further, although route server 202 and SDN controller 204 are shown as two separate entities, in certain embodiments the functions attributed to these components may be performed by a single entity (e.g., a combined route server/controller). One of ordinary skill in the art will recognize other variations, modifications, and alternatives.

### 3. Legacy-to-SDN Transformation Workflow

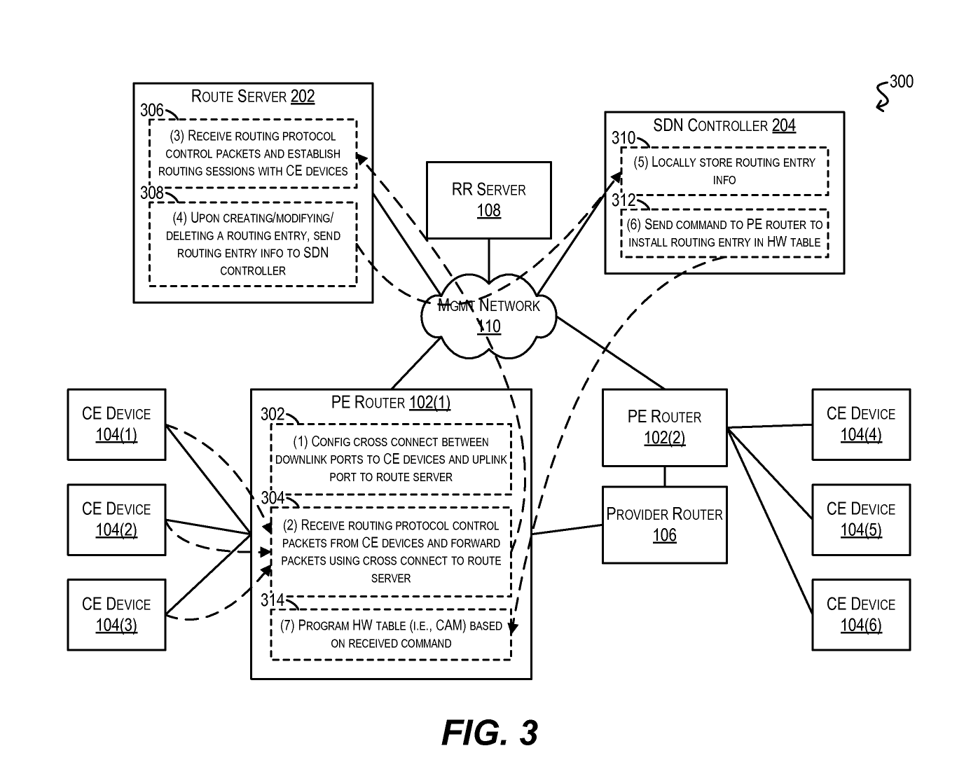

FIG. 3 depicts a workflow 300 that can be performed within network 200 of FIG. 2 for facilitating the conversion/transformation of the network into an SDN-enabled network according to an embodiment. Although workflow 300 describes steps that specifically pertain to PE router 102(1), it should be appreciated that a similar workflow can be carried out with respect to PE router 102(2) (as well as any other PE routers in the network).

Starting with step (1) of workflow 300 (reference numeral 302), PE router 102(1) can be configured to implement a “cross connect” between the downlink ports of the router (i.e., the ports connecting the router to CE devices 104(1)-(3)) and an uplink port between the router and management network 110 (leading to route server 202). The cross connect, which can be implemented using, e.g., one or more access control lists (ACLs) applied to the downlink or uplink ports, is adapted to automatically forward routing protocol (e.g., BGP, OSPF, ISIS, etc.) traffic originating from CE devices 104(1)-(3) to route server 202, without processing that traffic locally on the control plane of PE router 102(1).

At step (2) (reference numeral 304), PE router 102(1) can receive routing protocol control packets from one or more of CE devices 104(1)-(3) and can forward the packets via the cross connect to route server 202. In response, route server 202 can receive the routing protocol control packets and can establish/maintain routing protocol sessions with the CE devices that originated the packets (step (3), reference numeral 306). This step can include, e.g., populating a routing database based on information included in the received routing protocol packets, calculating best routes, and building one or more routing tables with routing entries for various destination IP addresses.

Upon creating, modifying, or deleting a given routing entry in its routing table(s), route server 202 can communicate information regarding the routing entry to SDN controller 204 (step (4), reference numeral 308). In certain embodiments, route server 202 can perform this communication by invoking a REST API exposed by SDN controller 204 for this purpose. In a particular embodiment, the API can be configured to register itself with route server 202's routing table(s), thereby allowing the API to be notified (and automatically invoked) whenever there is a routing table modification event (e.g., routing entry creation, update, deletion, etc.).

At step (5) (reference numeral 310), SDN controller 204 can receive and locally store the routing entry information in a local flow entry database. In one embodiment, route server 202 and/or SDN controller 204 can compact their respective databases using a fib aggregation algorithm, such as the SMALTA algorithm described at https://tools.ietf.org/html/draft-uzmi-smalta-01. The use of such an algorithm can avoid the need for expensive hardware on route server 202 and/or SDN controller 204 for accommodating large numbers of routing entries.

Finally, at steps (6) and (7) (reference numerals 312 and 314), SDN controller 204 can send a command (e.g., an OpenFlow command) for installing the created/modified routing entry to PE router 102(1), which can cause router 102(1) to program the routing entry into an appropriate hardware forwarding table (e.g., CAM) of the router. This will cause PE router 102(1) to subsequently forward, in hardware, future data traffic received from CE devices 104(1)-(3) according to the newly programmed routing entry. Note that, in some embodiments, this may require PE router 102(1) to support/understand OpenFlow (or whatever southbound communication protocol is used by SDN controller 204 to communicate the command at step (6)).

### 4. Route Server High Availability (HA)

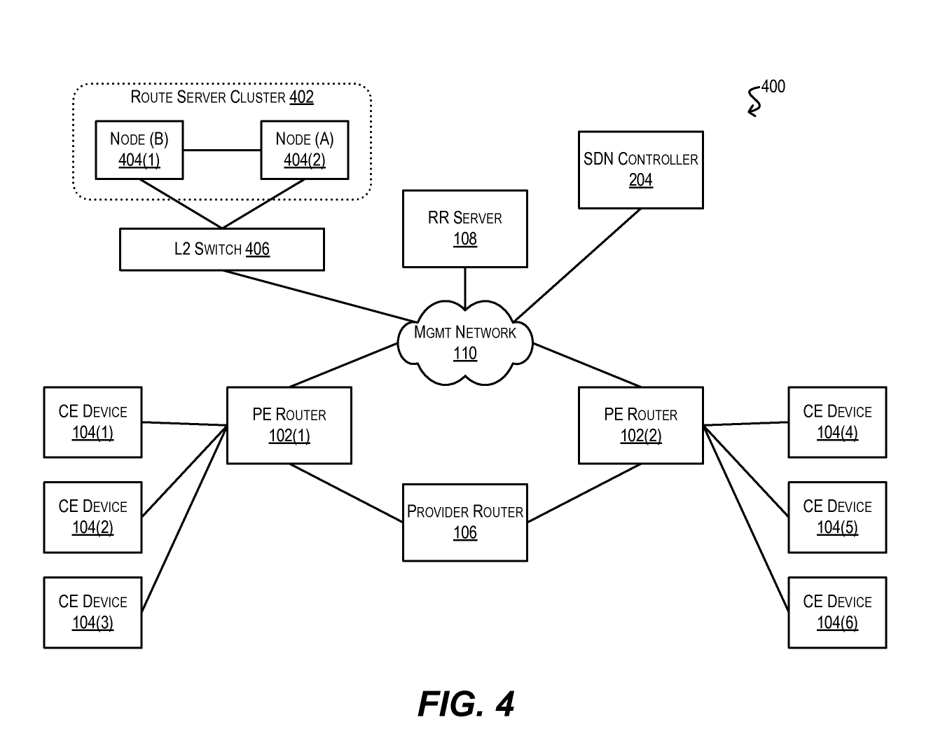

One potential downside with the network configuration shown in FIG. 2 is that route server 202 (which centrally performs control plane functions on behalf of PE routers 102(1) and 102(2)) is a singular point of failure; if route server 202 goes down, then the entire network will break down since CE devices 104(1)-(6) will not be able to setup routing protocol sessions with the route server. To avoid this scenario, FIG. 4 depicts an alternative implementation of SDN-enabled network 200 (shown as network 400) that makes use of a route server cluster 402 comprising multiple nodes, rather than a single route server machine. In the specific example of FIG. 4, route server cluster 402 includes two nodes 404(1) and 404(2) that are connected to management network 110 via a Layer 2 switch 406, where node 404(2) is the active node in the cluster and node 404(1) is the backup node in the cluster. The various nodes of route server cluster 402 can use, e.g., VRRP or VRRP-e to appear as a single server (having a single, virtual IP address) to the CE devices. When a routing protocol packet is received at the virtual IP address, the routing protocol packet can be processed by active node 404(2). If the active node 404(2) fails, backup node 404(1) can take over processing duties from the failed active node, thereby ensuring that the route server remains accessible and operational.

In certain embodiments, route server cluster 402 can carry out a novel workflow for (1) automatically synchronizing routing protocol state machines and routing databases between active node 404(2) and backup node 404(1); and (2) sending out routing protocol response (i.e., “transmit) packets to CE devices through backup node 404(1). This is in contrast to conventional VRRP implementations, where routing protocol transmit packets are always sent out by the active node. With this workflow, backup node 404(1) can always be properly synchronized with the state of active node 404(2), which can reduce failover time in the case of a failure of the active node.

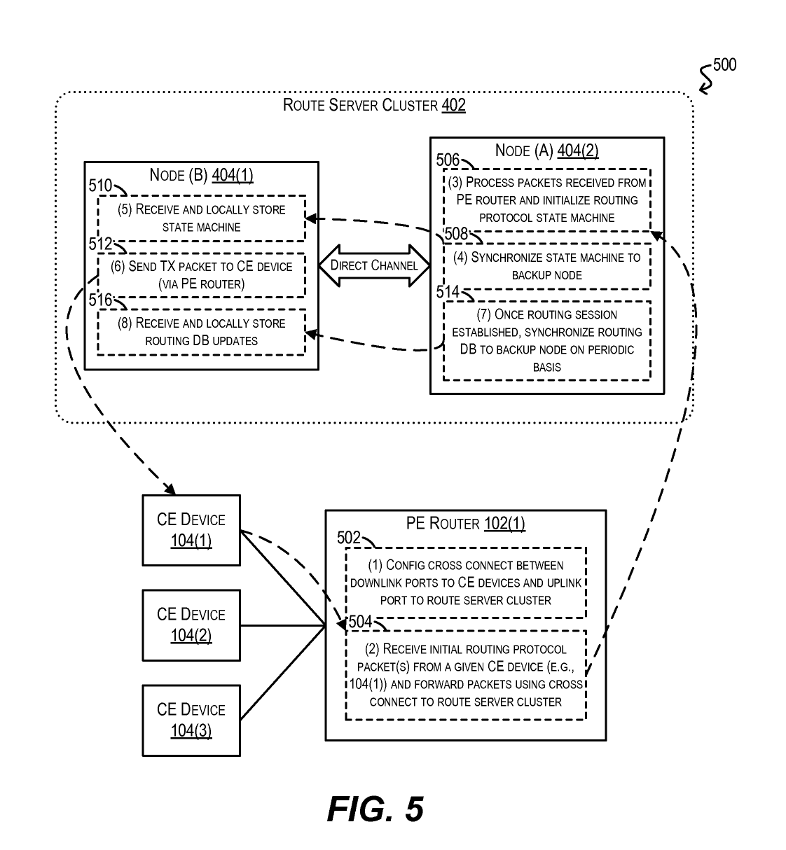

FIG. 5 depicts a workflow 500 for performing this HA synchronization in the context of network 400 of FIG. 4 according to an embodiment. In workflow 500, management network 110 and L2 switch 406 are omitted for clarity, although in various embodiments they may be assumed to be present and to facilitate the flow of packets between PE routers 102(1)/102(2) and route server cluster 402.

At step (1) of workflow 500 (reference numeral 502), PE router 102(1) can be configured with a cross connect between the downlink ports of PE router 102(1) that are connected to CE devices 104(1)-(3) and the uplink port of PE router 102(1) that is connected to route server cluster 402 (through management network 110 and L2 switch 406). This step is similar to step (1) of workflow 300, but involves redirecting routing protocol traffic (via the cross connect) to the virtual IP address of route server cluster 402, rather than to a physical IP address of a particular route server machine.

At step (2) (reference numeral 504), PE router 102(1) can receive initial routing protocol packet(s) from a given CE device (e.g., device 104(1)) and can forward the packets using the cross connect to the virtual IP address of route server cluster 402, without locally processing the packets on router 102(1). This causes the routing protocol packets to be received by active node 404(2) of the cluster.

At step (3) (reference numeral 506), active node 404(2) can process the routing protocol packets originated from CE device 104(1), which results in the initialization of a routing protocol state machine for tracking the session establishment process. Active node 404(2) can then synchronize this state machine with backup node 404(1) in the cluster over a direct communication channel (sometimes known as a “heartbeat connection”) (step (4), reference numeral 508). In one embodiment, this direct channel can be an Ethernet connection. This can cause backup node 404(1) to receive and locally store the state machine (step (5), reference numeral 510).

Once the routing protocol state machine has been synced per steps (4) and (5), backup node 404(1) (rather than active node 404(2)) can send out a response (i.e., a “transmit” packet) based on the synced state machine to CE device 104(1), via PE router 102(1) (step (6), reference numeral 512). This step of using backup node 404(1) to send out the transmit packet to CE device 104(1) advantageously ensures that the state machine has been synchronized properly between the active and backup nodes. For example, if the state machine on backup node 404(1) does not properly match the state machine on active node 404(2), the transmit packet sent out by backup node 404(1) will be incorrect/corrupt, which will cause CE device 104(1) to reset the session.

Finally, once the routing protocol session has been established and active node 404(2) has populated its routing database, active node 404(2) can synchronize the routing database with backup node 404(1) on a periodic basis over the same direct channel (steps (7) and (8), reference numerals 514 and 516). This can ensure that the failover time from active node 404(2) to backup node 404(1) is minimal, since there is no need for backup node 404(1) to rebuild the routing database in the case of a failure of active node 404(2).

### 5. Network Router

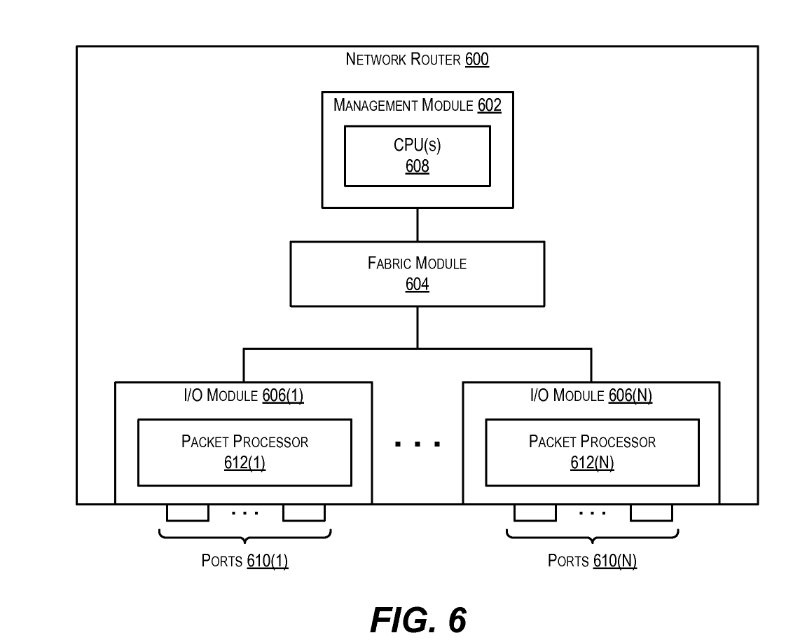

FIG. 6 depicts an exemplary network router 600 according to an embodiment. Network router 600 can be used to implement, e.g., PE routers 102(1) and 102(2) described in the foregoing disclosure.

As shown, network router 600 includes a management module 602, a fabric module 604, and a number of I/O modules 606(1)-606(N). Management module 602 represents the control plane of network router 600 and thus includes one or more management CPUs 608 for managing/controlling the operation of the router. Each management CPU 608 can be a general purpose processor, such as a PowerPC, Intel, AMD, or ARM-based processor, that operates under the control of software stored in an associated memory (not shown).

Fabric module 604 and I/O modules 606(1)-606(N) collectively represent the data, or forwarding, plane of network router 600. Fabric module 604 is configured to interconnect the various other modules of network router 600. Each I/O module 606 can include one or more input/output ports 610(1)-610(N) that are used by network router 600 to send and receive data packets. Each I/O module 606 can also include a packet processor 612. Each packet processor 612 is a hardware processing component (e.g., an FPGA or ASIC) that can make wire speed decisions on how to handle incoming or outgoing data packets. For example, in various embodiments, each packet processor 612 can include (or be coupled to) a hardware forwarding table (e.g., CAM) that is programmed with routing entries determined by route server 202, as described in the foregoing embodiments.

It should be appreciated that network router 600 is illustrative and not intended to limit embodiments of the present invention. Many other configurations having more or fewer components than router 600 are possible.

### 6. Computer System

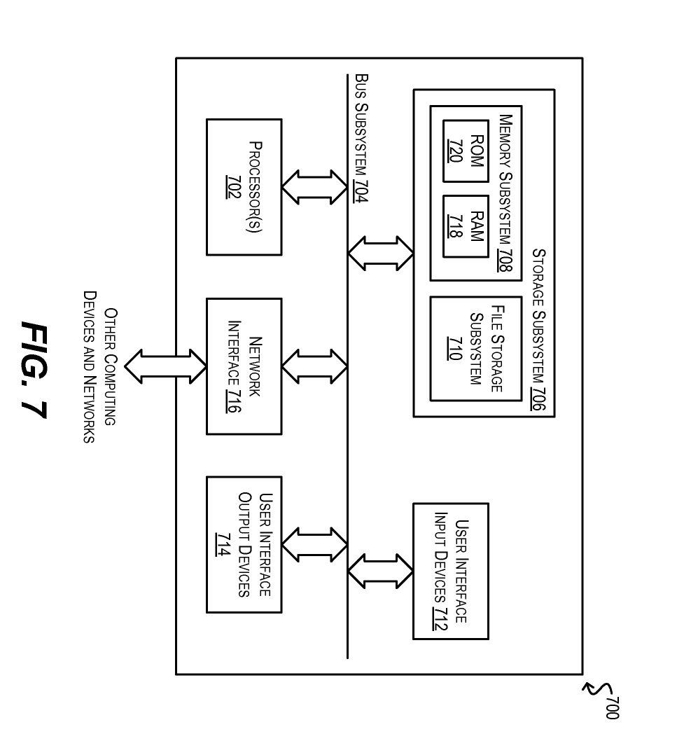

FIG. 7 depicts an exemplary computer system 700 according to an embodiment.

Computer system 700 can be used to implement, e.g., route server 202, route server cluster nodes 404(1)-(2), and/or SDN controller 204 described in the foregoing disclosure. As shown in FIG. 7, computer system 700 can include one or more processors 702 that communicate with a number of peripheral devices via a bus subsystem 704. These peripheral devices can include a storage subsystem 706 (comprising a memory subsystem 708 and a file storage subsystem 710), user interface input devices 712, user interface output devices 714, and a network interface subsystem 716.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple busses.

Network interface subsystem 716 can serve as an interface for communicating data between computer system 700 and other computing devices or networks. Embodiments of network interface subsystem 716 can include wired (e.g., coaxial, twisted pair, or fiber optic Ethernet) and/or wireless (e.g., Wi-Fi, cellular, Bluetooth, etc.) interfaces.

User interface input devices 712 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 700.

User interface output devices 714 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 700.

Storage subsystem 706 can include a memory subsystem 708 and a file/disk storage subsystem 710. Subsystems 708 and 710 represent non-transitory computer-readable storage media that can store program code and/or data that provide the functionality of various embodiments described herein.

Memory subsystem 708 can include a number of memories including a main random access memory (RAM) 718 for storage of instructions and data during program execution and a read-only memory (ROM) 720 in which fixed instructions are stored. File storage subsystem 710 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and not intended to limit embodiments of the present disclosure. Many other configurations having more or fewer components than computer system 700 are possible.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
receiving, by a route server, one or more routing protocol packets originating from a network device, the one or more routing protocol packets being forwarded to the route server through a network router;
establishing, by the route server, a routing protocol session between the route server and the network device based on the one or more routing protocol packets;
subsequently to establishing the routing protocol session, adding, by the route server, a routing entry to a local routing table; and
upon adding the routing entry, automatically invoking, by the route server, an application programming interface (API) for transmitting the routing entry to a Software Defined Networking (SDN) controller.

2. The method of claim 1 wherein the one or more routing protocol packets are forwarded to the route server via a cross connect configured on the network router, the cross connect establishing a path between a downlink port connecting the network router to the network device and an uplink port connecting the network router to the route server, such that all routing protocol traffic received at the downlink port is automatically redirected to the uplink port.

3. The method of claim 2 wherein the cross connect is implemented using an access control list (ACL) that is associated with the downlink port or the uplink port.

4. The method of claim 1 wherein the one or more routing protocol packets are forwarded to the route server through the network router without being locally processed by a control plane of the network router.

5. The method of claim 1 wherein the API is registered with the local routing table, such that the API is automatically invoked upon a routing entry insertion, modification, or deletion in the local routing table.

6. The method of claim 1 wherein the route server is implemented as a cluster comprising a plurality of nodes, the cluster being operable to provide route server redundancy.

7. The method of claim 6 wherein the plurality of nodes include an active node and a backup node, and wherein the active node is operable to establish the routing protocol session with the network device.

8. The method of claim 7 wherein establishing the routing protocol session by the active node comprises:
synchronizing a routing protocol state machine for the routing protocol session from the active node to the backup node; and
causing the backup node to transmit routing protocol response packets to the network device.

9. The method of claim 7 wherein the active node is further operable to synchronize updates to a routing database of the active node to the backup node upon establishment of the routing protocol session.

10. The method of claim 1 wherein the API is a standardized representational state transfer (REST) API exposed by the SDN controller.

11. The method of claim 1 wherein, upon receiving the invocation of the API, the SDN controller is operable to:
add the routing entry to a local flow entry database; and
transmit a command to the network router for installing the routing entry in a hardware forwarding table of the network router.

12. The method of claim 11 wherein the SDN controller is further operable to compact the local flow entry database on a periodic basis using a fib aggregation algorithm.

13. A non-transitory computer readable storage medium having stored thereon program code executable by a processor of a route server, the program code causing the processor to:
receive one or more routing protocol packets originating from a network device, the one or more routing protocol packets being forwarded to the route server through a network router;
establish a routing protocol session between the route server and the network device based on the one or more routing protocol packets;
subsequently to establishing the routing protocol session, add a routing entry to a local routing table; and
upon adding the routing entry, automatically invoke an application programming interface (API) for transmitting the routing entry to a Software Defined Networking (SDN) controller.

14. The non-transitory computer readable storage medium of claim 13 wherein the one or more routing protocol packets are forwarded to the route server via a cross connect configured on the network router, the cross connect establishing a path between a downlink port connecting the network router to the network device and an uplink port connecting the network router to the route server, such that all routing protocol traffic received at the downlink port is automatically redirected to the uplink port.

15. The non-transitory computer readable storage medium of claim 13 wherein the one or more routing protocol packets are forwarded to the route server through the network router without being locally processed by a control plane of the network router.

16. The non-transitory computer readable storage medium of claim 13 wherein the route server is implemented as a cluster comprising a plurality of nodes, the cluster being operable to provide route server redundancy,
wherein the plurality of nodes include an active node and a backup node, the active node being operable to establish the routing protocol session with the network device, and
wherein the active node establishes the routing protocol session by:
synchronizing a routing protocol state machine for the routing protocol session from the active node to the backup node; and
causing the backup node to transmit routing protocol response packets to the network device.

17. A computer system comprising:
one or more processors; and
a non-transitory computer readable medium having stored thereon program code that, when executed by the one or more processors, causes the one or more processors to:
receive one or more routing protocol packets originating from a network device, the one or more routing protocol packets being forwarded to the computer system through a network router;
establish a routing protocol session between the computer system and the network device based on the one or more routing protocol packets;
subsequently to establishing the routing protocol session, add a routing entry to a local routing table; and
upon adding the routing entry, automatically invoke an application programming interface (API) for transmitting the routing entry to a Software Defined Networking (SDN) controller.

18. The computer system of claim 17 wherein the one or more routing protocol packets are forwarded to the computer system via a cross connect configured on the network router, the cross connect establishing a path between a downlink port connecting the network router to the network device and an uplink port connecting the network router to the computer system, such that all routing protocol traffic received at the downlink port is automatically redirected to the uplink port.

19. The computer system of claim 17 wherein the one or more routing protocol packets are forwarded to the computer system through the network router without being locally processed by a control plane of the network router.

20. The computer system of claim 17 wherein the computer system is implemented as a cluster comprising a plurality of nodes, the cluster being operable to provide route server redundancy,
wherein the plurality of nodes include an active node and a backup node, the active node being operable to establish the routing protocol session with the network device, and
wherein the active node establishes the routing protocol session by:
synchronizing a routing protocol state machine for the routing protocol session from the active node to the backup node; and
causing the backup node to transmit routing protocol response packets to the network device.
